(19) United States
(12) Patent Application Publication
(10) Pub. No.: US 2025/0337846 A1
(43) Pub. Date: Oct. 30, 2025

(54) INSPECTION APPARATUS, METHOD FOR CONTROLLING THE INSPECTION APPARATUS, AND STORAGE MEDIUM

(71) Applicant: CANON KABUSHIKI KAISHA, Tokyo (JP)

(72) Inventor: TAKESHI SHINYA, Chiba (JP)

(21) Appl. No.: 19/184,126

(22) Filed: Apr. 21, 2025

(30) Foreign Application Priority Data
Apr. 24, 2024 (JP) 2024-070855

(51) Int. Cl. H04N 1/00

(52) U.S. Cl. CPC H04N 1/0009; H04N 1/00045

(57) ABSTRACT

The present disclosure makes it possible to avoid the shortage of the capacity of a storage device storing reference image data and maintain the convenience to a user in a case of the reuse of a print job. An inspection apparatus performing an inspection of printed material includes a setting unit configured to set reference image data generated based on print data on the printed material for the inspection and a storing unit configured to store the set reference image data according to an inspection method and hold the stored reference image data in order to reuse it for another inspection even after the inspection is performed.

### CROSS-REFERENCE TO PRIORITY APPLICATION

This application claims the benefit of Japanese Patent Application No. 2024-070855 filed Apr. 24, 2024, which is hereby incorporated by reference wherein in its entirety.

### BACKGROUND

### Field

The present disclosure relates to a technique of inspecting printed material.

### Description of the Related Art

Conventionally, an inspection operation is performed in a print industry in order to guarantee that a product (printed material) to be delivered to a purchaser has no defect and there is no problem with the quality of the product. A printing system provided with an inline automatic inspection function in which this inspection operation is continuously performed after a printing process is also widely used. Further, a method for inspection includes a technique called “scan inspection” and a technique called “RIP inspection.” In the “scan inspection,” first, a printing result without a defect is read with a scanner to obtain and register image data (reference image data) which is an inspection reference. Next, a printing process is performed based on input document image data (also referred to as “print job”) and printed material is read with the scanner to obtain image data (inspection image data) to be an inspection target. Further, the presence or absence of a defect in the printed material is determined by comparing the inspection image data with the reference image data which is registered in advance. In contrast, the “RIP inspection” is a technique to generate and obtain the abovementioned reference image data from the input document image data. For a printing process, raster image data (print data) obtained by interpreting PDL (Page Description Language) included in the print job is used. Since this print data has no defect, an adjustment of the resolution is performed on the print data and the print data is made into reference image data.

In preparation for a case where a performed print job is reused, corresponding reference image data can be stored in a print system with the print job. In this case, the reference image data is stored the same number of times as the number of print jobs, but as the number of stored print jobs increases, a more strain is placed on the capacity of a storage device with which the print system is provided. In this regard, Japanese Patent Laid-Open No. 2020-049899 describes a technique of automatically deleting reference image data under a predetermined condition in a case where the volume of the reference image data stored in a storage device exceeds a predetermined amount. However, in the method disclosed in Japanese Patent Laid-Open No. 2020-049899, the reference image data remains stored until the volume of the stored data reaches the predetermined amount, and thus the effect of avoiding shortage of the capacity of the storage device is limited. Further, the reference image data is automatically deleted at the point in time of reaching the predetermined amount, and thus there may arise the deletion of reference image data which a user does not intend. The present disclosure is made in the light of such a problem.

### SUMMARY

An inspection apparatus performing an inspection of printed material according to the present disclosure includes: one or more memories storing instructions; and one or more processors executing the instructions to: set reference image data generated based on print data on the printed material for the inspection; and store the set reference image data according to an inspection method and hold the stored reference image data in order to reuse it for another inspection even after the inspection is performed.

Further features of the present disclosure will become apparent from the following description of exemplary embodiments with reference to the attached drawings.

### BRIEF DESCRIPTION OF THE DRAWINGS

FIG. 1 is a diagram illustrating an example of an overall configuration of a print system;

FIG. 2 is a diagram illustrating an example of a hardware configuration of an image processing apparatus;

FIG. 3 is a diagram illustrating an example of a hardware configuration of an image forming apparatus, an inspection apparatus, and a post-processing apparatus;

FIG. 4 is a diagram illustrating an example of an internal hardware configuration of an inspection process unit;

FIG. 5 is a diagram illustrating an example of functional blocks of the print system;

FIG. 6 is a flowchart illustrating a flow of operations of the print system based on a new job;

FIG. 7 illustrate an example of a UI screen to select an inspection method;

FIG. 8 is a flowchart illustrating the details of a print process;

FIG. 9 is a flowchart illustrating a flow of operations of the print system based on a stored job; and

FIG. 10 illustrates an example of a UI screen to perform setting on the storing of reference image data.

### DESCRIPTION OF THE EMBODIMENTS

Hereafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### <Configuration of an Overall System>

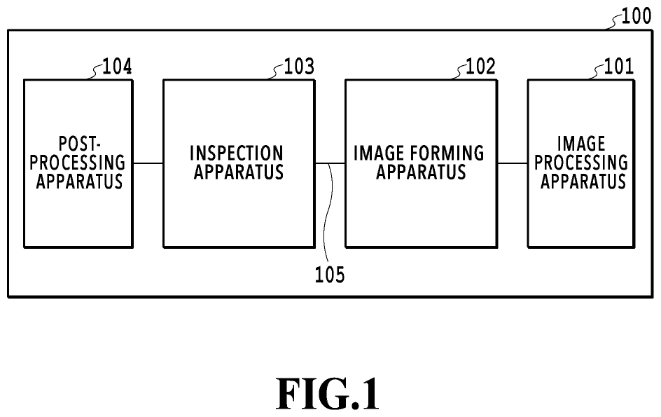

FIG. 1 is an overall configuration diagram of a print system 100 according to the present embodiment. The print system 100 has an image processing apparatus 101, an image forming apparatus 102, an inspection apparatus 103, and a post-processing apparatus 104, and each apparatus is connected to the other apparatuses via a communication cable 105.

A role of each apparatus to realize a function which the print system 100 has is briefly described. The image processing apparatus 101 is also referred to as a DFE (Digital Front End) and plays a role as a printer sever. In other words, the image processing apparatus 101 performs RIP processing to make PDL data included in an input print job bitmapped and generates raster image data (print data) to be used by the image forming apparatus 102 in the print process. Further, the image processing apparatus 101 performs control of the print process performed by the image forming apparatus 102 and manages the print job. The image forming apparatus 102 is a printer forming an image on a sheet which is a printing medium based on the print data generated by the image processing apparatus 101. An image forming method includes, but is not specifically limited to, offset printing, electrophotography, an inkjet method, and the like. In the present embodiment, the image forming apparatus 102 is described as being an electrophotographic image forming apparatus. The inspection apparatus 103 inspects a sheet (printed material) to which the print process is applied by the image forming apparatus 102 for defects and the quality of the sheet for problems. The post-processing apparatus 104 is also referred to as a finisher and performs post processing such as sorting, grouping, and stapling in addition to discharge control based on a result of an inspection performed by the inspection apparatus 103.

### <Hardware Configuration of Each Apparatus>

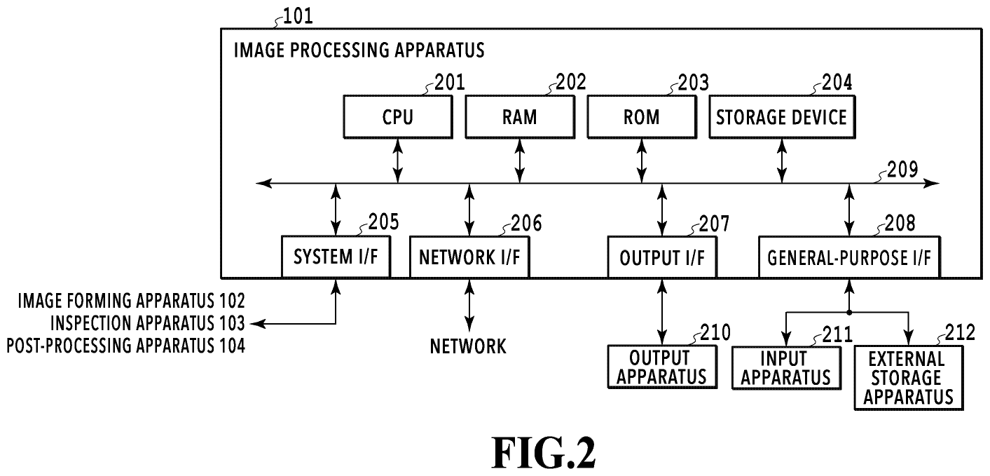

Next, a hardware configuration of each apparatus constituting the print system 100 is described. FIG. 2 is a diagram schematically illustrating an internal configuration of the image processing apparatus 101. The image processing apparatus 101 includes a CPU 201, a RAM 202, a ROM 203 a storage device 204, a system I/F 205, a network I/F 206, an output I/F 207, a general-purpose I/F 208, and a main bus 209. Further, an output apparatus 210 is connected to the image processing apparatus 101 via the output I/F 207, and an input apparatus 211 and an external storage apparatus 212 are connected to the image processing apparatus 101 via the general-purpose apparatus I/F 208.

The CPU 201 is a processor controlling each unit which the image processing apparatus 101 has. In the present embodiment, the CPU 201 is described as one totally controlling the overall printing system 100, but is not limited to such a configuration and may have a configuration in which the CPU 201 shares processing with another CPU and a configuration in which a GPU which is a processor specializing in a high speed parallel calculation takes a role in part of a control process of the CPU 201. Further, part of the control process of the CPU 201 may be performed by using hardware such as an ASIC (Application Specific Integrated Circuit) or a FPGA (Field Programmable Gate Array). The RAM 202 is a volatile memory functioning as a main memory and a work area of the CPU 201. The ROM 203 is a volatile memory storing a group of programs such as an OS executed by the CPU 201. The storage device 204 is a non-volatile large-capacity storage unit such as an HDD and an SDD and stores an application executed by the CPU 201 and various types of data or the like. The system I/F 205 is an communication interface connected to each apparatus in the print system 100, that is, the image forming apparatus 102, the inspection apparatus 103, and the post-processing apparatus 104 to exchange various types of data with the apparatuses. Each apparatus communicates an operational status with the others through the system I/F 205, synchronizes operational timing and sends and receives data to and from the other apparatuses. The network I/F 206 is an interface connected to a network outside the print system 100 and sending and receiving data. The output I/F 207 is an image output interface such as HDMI®. The output apparatus 210 connected to the image processing apparatus 101 via the output I/F 207 is, for example, a liquid crystal display and provides a GUI (graphical user interface) or the like. The general-purpose I/F 208 is a bus interface such as USB and IEEE 1349. Information on an operation (instruction) performed by a user is accepted from the input apparatus 211 such as a keyboard or a mouse connected to the image processing apparatus 101 via the general-purpose I/F 208. Further, the image processing apparatus 101 is connected to the external storage apparatus 212 via the general-purpose I/F 208, and the user can make the external storage apparatus 212 store data such as a log and make the image processing apparatus 101 obtain desired data from the external storage apparatus 212. The main bus 209 mutually communicably connects each of pieces of the hardware which the image processing apparatus 101 includes. Incidentally, the hardware configuration of the image processing apparatus 101 is not limited to the above configuration. For instance, there may exist a display apparatus such as a liquid crystal display providing a GUI via the main bus 209 inside the image processing apparatus 101. Further, the output apparatus 210 may be integrated with the input apparatus 211 as a touch panel display, or the like.

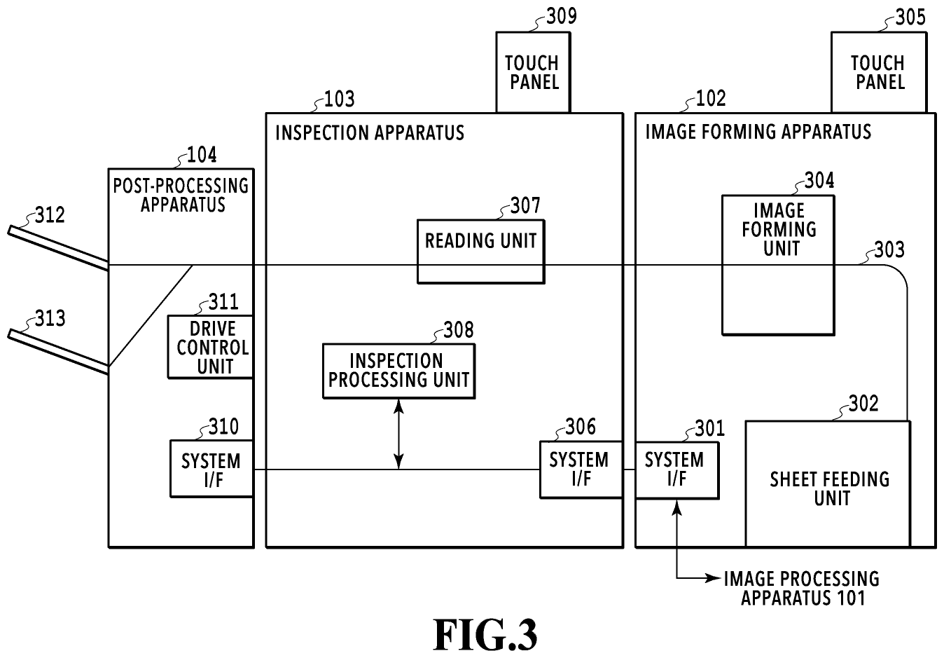

FIG. 3 is a diagram schematically illustrating a hardware configuration of the image forming apparatus 102, the inspection apparatus 103, and the post-processing apparatus 104.

The image forming apparatus 102 is connected to the other apparatuses in the print system 100 via the system I/F 301. The image forming apparatus 102 includes a sheet feeding unit 302, a conveyance unit 303, an image forming unit 304, and a touch panel 305. The sheet feeding unit 302 supplies a sheet set in a cassette not illustrated or the like to the inside of the image forming apparatus 102 through the conveyance unit 303. The conveyance unit 303 conveys the sheet set in the sheet feeding unit 302 by using a rotation roller (not illustrated) or the like. The conveyance unit 303 can convey the sheet from the image forming apparatus 102 to the inspection apparatus 103 and the post-processing apparatus 104. In other words, the conveyance unit 303 leads to the inspection apparatus 103 and the post-processing apparatus 104 and is an element common to the three apparatuses. The image forming unit 304 forms an image on the sheet conveyed by the conveyance unit 303 based on the print data sent from the image processing apparatus 101. In a case where a print method is electrophotography, an image indicated by the print data is latently formed on a photoconductive drum, developed with a color material (toner), transferred to the sheet, and fixed to form the image on the sheet. The touch panel 305 is a combination of a display apparatus (for example, a liquid crystal display) and a pointing device (for example, a touch pad) and is equivalent to the output apparatus 210 and the input apparatus 211 of the image processing apparatus 101.

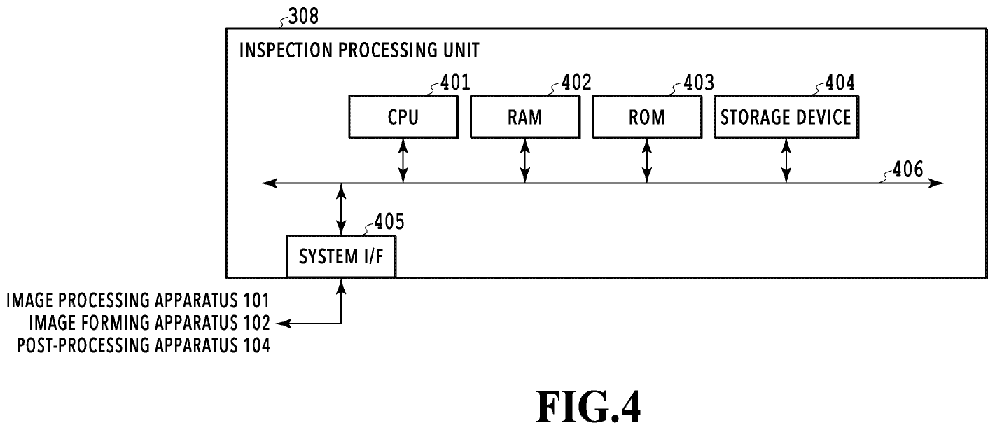

The inspection apparatus 103 is connected to other apparatuses in the print system 100 via a system I/F 306. The inspection apparatus 103 includes a reading unit 307, an inspection processing unit 308, and a touch panel 309. The reading unit 307 is a scanner including a light source and a light receiving sensor (a CCD or the like) inside, optically reads the printed material conveyed by the conveyance unit 303, and obtains the printed material as image data. Hereinafter, the image data read by the reading unit 307 is referred to as “read data.” The read data of the present embodiment has an image format in which each pixel has three channels of RGB (Red, Green, Blue) and each channel has 8 bits. The inspection processing unit 308 inspects the printed material for a defect by comparing read data obtained by the reading unit 307 with reference image data corresponding to the read data. FIG. 4 is a diagram illustrating an example of a hardware configuration inside the inspection processing unit 308. The inspection processing unit 308 includes a CPU 401, a RAM 402, a ROM 403, a storage device 404, a system I/F 405, and a main bus 406. These pieces of hardware are equivalent to the CPU 201, the RAM 202, the ROM 203, the storage device 204, the system I/F 205, and the main bus 209 illustrated in FIG. 2, respectively, and a description thereof is omitted because the function of each piece of hardware is mentioned above. The touch panel 309 is a combination of a display apparatus (for example, a liquid crystal display) and a pointing device (for example, a touch pad) and is equivalent to the touch panel 305 of the image forming apparatus 102.

The post-processing apparatus 104 is connected to the other apparatuses in the print system 100 via a system I/F 310. The post-processing apparatus 104 includes a drive control unit 311 and a discharge tray 312/313. In FIG. 3, a hardware configuration to realize functions such as sorting, grouping, and stapling is omitted. The drive control unit 311 performs control to switch paths so that printed material conveyed by the conveyance unit 303 is discharged to the discharge tray 312 or 313 according to an inspection result of the inspection apparatus 103. The printed material is distinguished into an accepted material and a rejected material, for example and is discharged by the drive control unit 311.

### <Functional Configuration of the Print System>

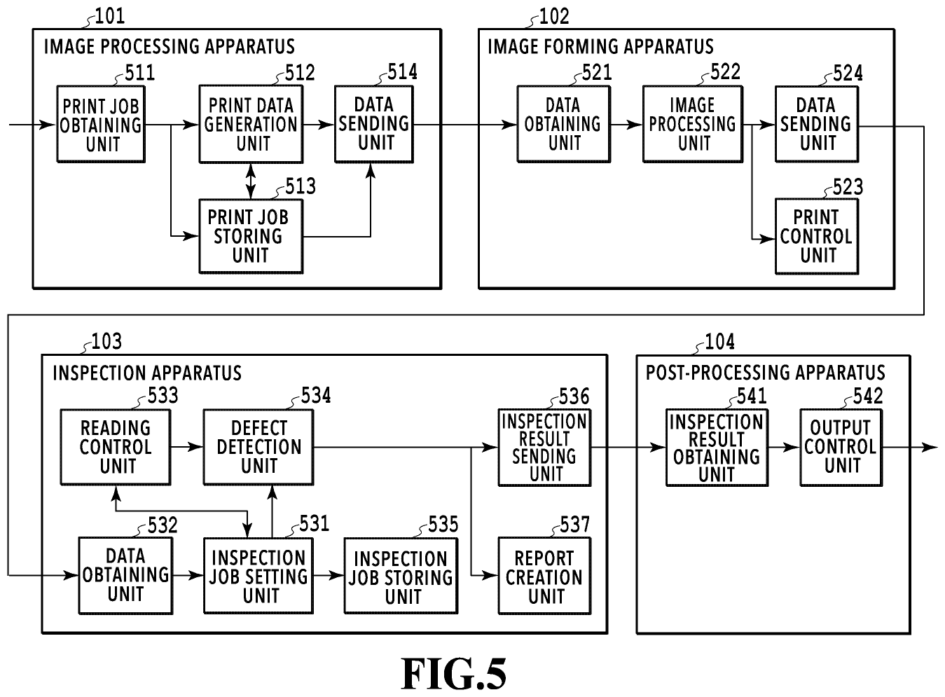

Next, with reference to a functional block diagram of FIG. 5, a functional configuration (software configuration) of each apparatus constituting the print system 100 is described.

The image processing apparatus 101 has a print job obtaining unit 511, a print data generation unit 512, a print job storing unit 513, and a data sending unit 514. The function of each unit is briefly described. The print job obtaining unit 511 obtains a print job composed of data (PDL data) in which an image to be printed is described in units of pages and header information. Here, the header information includes, in addition to information on print conditions such as the number of printed copies, and the type and the size of a sheet (print setting), information indicating whether to store the print job in preparation for reuse (storage setting). The print job is, for example, input with a print instruction from a personal computer (not illustrated) which can communicate with the image processing apparatus 101 via a network, or may be obtained as a result of the user inputting the print conditions or the like as mentioned above to the PDL data via the input apparatus 211 to generate the print job in the image processing apparatus 101. The print data generation unit 512 performs an RIP process based on the print settings included in the header information of the input print job and the PDL data to generate the print data. The print job storing unit 513 performs a process for continuing to store (process for holding) the print job in the storage device 204 in a case where storage setting included in the header information of the input print job designates the storing of the print job even after the print job is performed. The storage setting is, for example, binary flag information expressing a case where the print job is to be stored as “1”and a case where the print job is not to be stored as “0.” The data sending unit 514 sends the print data or the like generated by the print data generation unit 512 to the image forming apparatus 102 via the system I/F 205.

The image forming apparatus 102 has a data obtaining unit 521, an image processing unit 522, a print control unit 523, and a data sending unit 524. The data obtaining unit 521 receives and obtains the print data sent by the data sending unit 514 of the image processing apparatus 101 via the system I/F 301. The image processing unit 522 performs a color conversion process, a halftone process, a correction process, or the like on the print data according to the print characteristics of the image forming unit 304. Hereinafter, the print data processed according to the print characteristics is referred to as “image forming data.” The print control unit 523 controls the image forming unit 304 and performs a process (print process) for forming an image on a sheet based on the image forming data. The data sending unit 524 sends the print data (or the image forming data) or an end signal indicating that the print process has been performed to the inspection apparatus 103 via the system I/F 301.

The inspection apparatus 103 has an inspection job setting unit 531, a data obtaining unit 532, a reading control unit 533, a defect detection unit 534, an inspection job storing unit 535, an inspection result sending unit 536, and a report creation unit 537. The user who desires to inspect the printed material by using an automatic inspection function does setting work of an inspection job after specifying a target print job. In this case, reference image data for detecting a defect (also referred to as “correct image data”) is generated according to an inspection method. The inspection job setting unit 531 generates the reference image data by performing predetermined image processing on the print data sent by the image forming apparatus 102 in a case where the inspection method is the “RIP inspection.” In contrast, in a case of the “scan inspection,” the inspection job setting unit 531 obtains read data on a result material (printed material) obtained by performing a print process on only a piece of print data and uses the read data as reference image data. The inspection job setting unit 531 associates header information including inspection conditions as mentioned below input by the user and the reference image data obtained according to the inspection method with the target print job and sets the header information and the reference image data as “inspection job.” The data obtaining unit 532 receives and obtains the print data and the end signal sent by the data sending unit 524 of the image forming apparatus 102 via the system I/F 306. The reading control unit 533 makes the reading unit 307 perform reading (scanning) of the printed material conveyed by the conveyance unit 303 based on the obtained end signal and obtains read data. The defection detection unit 534 compares the read data with the reference image data and performs a process to detect a defect in the printed material (inspection process) according to inspection setting in the inspection job which is set. The inspection job storing unit 535 associates the inspection job with the print job and stores the inspection job in the storage device 404 in a case where the print job associated with the inspection job is stored even after the print job is performed. In this case, all data including the reference image data is stored in a case where the inspection method designated in the inspection setting is the “scan inspection,” but remaining data which excludes the reference image data is stored in a case where the inspection method is the “RIP inspection.” In a case where a print target image has, for example, a size of A3 and a resolution of 600 DPI and each pixel has 8-bit pixel values of RGB, the data size of the corresponding reference image is approximately 200 MB per page. There is a case where 1000 pages or more are inspected per printed copy in, for example, bookbinding printing, and in such a case, the data size of the reference image is over 200 GB on a simple calculation. Storing all such reference image data having an enormous data size in preparation for reuse causes the shortage of the capacity of the storage device 404, and therefore a determination whether to perform the storing is made according to the inspection method in the present embodiment. The details of a method for storing the reference image data are described below. The inspection result sending unit 536 sends a result of the inspection process performed by the defect detection unit 534 to the post-processing apparatus 104 via the system I/F 306. The report creation unit 537 creates an inspection report summarizing the result of the inspection process performed by the defect detection unit 532.

The post-processing apparatus 104 has an inspection result obtaining unit 541 and an output control unit 542. The inspection result obtaining unit 541 receives and obtains the inspection result sent by the inspection result sending unit 536 of the inspection apparatus 103 via the system I/F 310. The output control unit 542 gives an instruction based on the obtained inspection result to the drive control unit 311 and performs control so that the printed material is discharged to a proper discharge tray (either 312 or 313).

### <Operation Flow of the Print System>

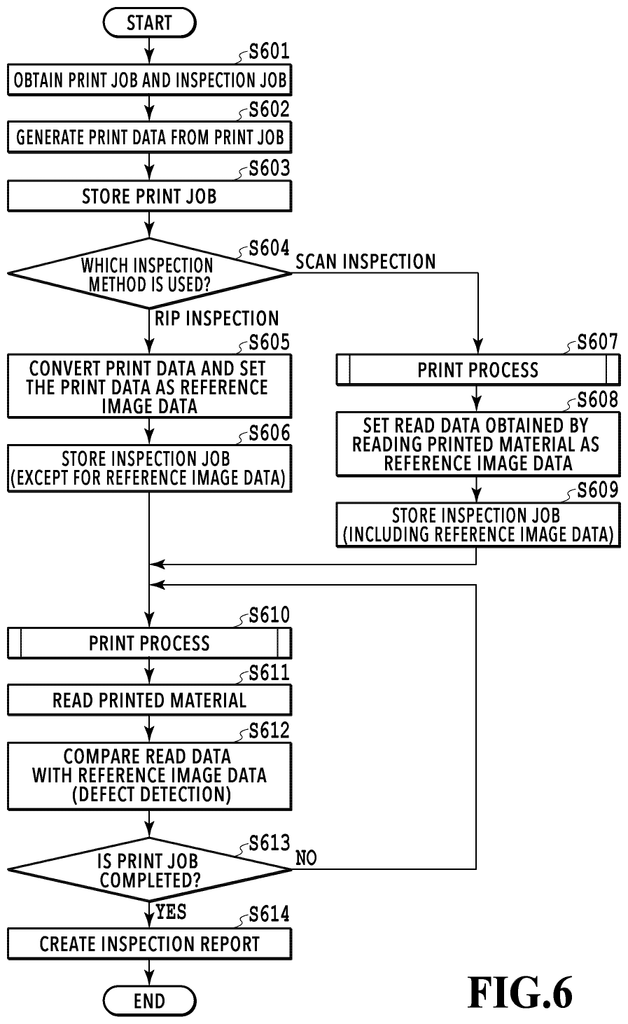

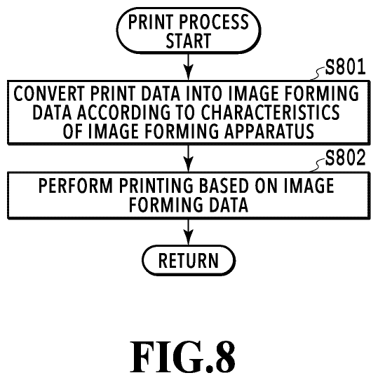

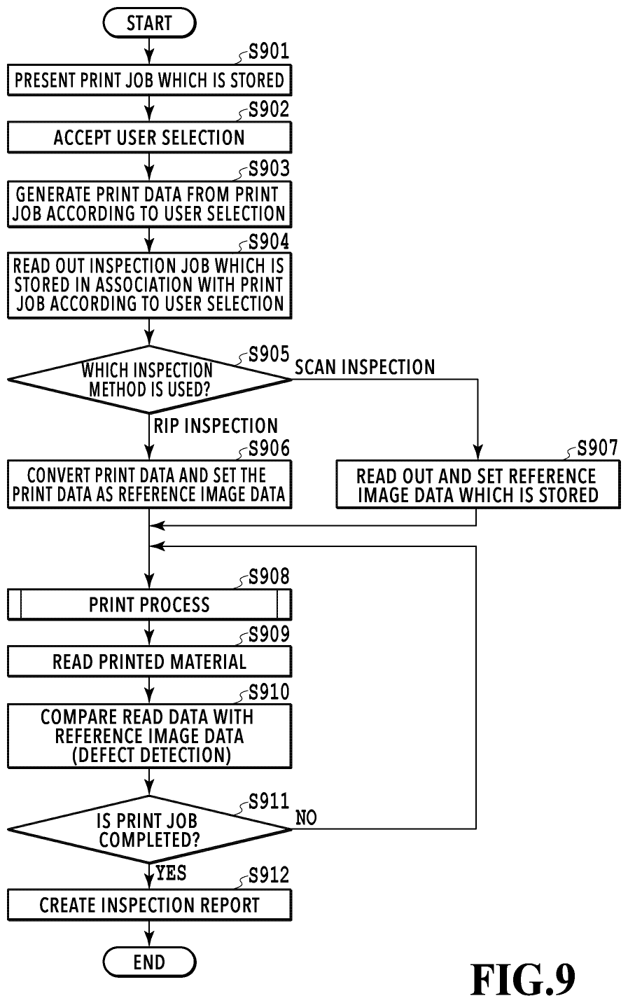

Next, the flow of operations of the print system 100 according to the present embodiment is described with reference to the flowcharts illustrated in FIG. 6, FIG. 8, and FIG. 9. FIG. 6 is a flowchart illustrating the flows of a print process and an inspection process based on a new print job and a new inspection job. FIG. 8 is a flowchart illustrating the details of the print process. FIG. 9 is a flowchart illustrating the flow of a print process and an inspection process based on a stored print job and an inspection job. Of a sequence of processes illustrated in the flowcharts in FIGS. 6 and 9, the CPU 201 of the image processing apparatus 101 mainly takes a role of what is related to the print process, and the CPU 401 of the inspection processing unit 308 of the inspection apparatus 103 mainly takes a role in what is related to the inspection process. Incidentally, in the following descriptions, the symbol “S” means a step.

### «Operation Flow Based on a New Job»

First, the print and inspection processes based on the print job and the inspection job which are newly input are described with reference to the flowchart in FIG. 6. The present embodiment is focused on the point that the reference image data in the RIP inspection can be easily regenerated by converting the print data, and the storing of the reference image data is not performed even in a case where an inspection job is scheduled to be reused. In contrast, much time and cost are required to obtain the reference image data in the scan inspection because the print process and read processing are necessary, and thus the reference image data is stored in a case where the inspection job is scheduled to be reused.

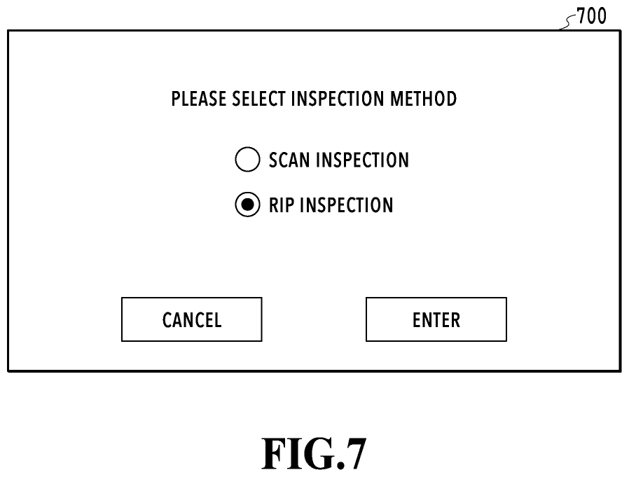

In S601, the print job and the inspection job to be processing targets are obtained. As mentioned above, the print job is obtained by being received from, for example, a PC not illustrated or the like. Further, the inspection job is obtained as a result of the user performing setting via a UI of the inspection apparatus 103. In a case of the setting of the inspection job, the user identifies which print job corresponds to the inspection job on the touch panel 309 and inputs inspection conditions such as the inspection method (“RIP inspection” or “scan inspection”), an inspection item, an inspection level or the like via the touch panel 309. Here, the inspection method is designated via, for example, a UI screen 700 illustrated in FIG. 7. The inspection item designates the type of defect to be detected. A defect in the printed material is caused because a color material is adhered to an unintended portion in the print process or because a sufficient amount of a color material is not adhered to an intended portion, and the type of defect includes a dot-shaped defect, a linear defect, color loss, and irregular color.

In S602, the print data generation unit 512 performs the RIP process based on the header information and the image data (PDL data) included in the print job obtained in S601. The print data which is raster image data in which each print condition prescribed in the header information is reflected and which can be treated in the image forming apparatus 102 is generated by the RIP process.

In S603, the print job storing unit 513 refers to the header information on the print job obtained in S601 and stores the print job in the storage device 204 in a case where an instruction to store the print job is made in the storage setting.

In S604, the inspection job setting unit 531 determines whether the inspection method is the RIP inspection or scan inspection based on the header information on the inspection job obtained in S 601. In a case of the RIP inspection, S 605 is performed next, and in a case of the scan inspection, S607 is performed next.

In S605, the inspection job setting unit 531 obtains the print data generated in S602 from the image forming apparatus 102 and performs predetermined image processing on the print data to generate the reference image data. Specifically, image processing such as resolution conversion and color conversion is performed on the print data. Having no defect, the print data is suitable for the reference image data. However, the print data cannot be compared with the read data without conversion. For example, the image resolution of the read data is determined by the conveyance speed of the conveyance unit 303 and the read frequency of the reading unit 307, but this is irrelevant to a print process system, and thus the image resolution of the read data and that of the print data are not always the same. Therefore, a process to adjust a resolution so that the resolution of the print data is equal to that of reference image data for comparison is necessary. Incidentally, in a case of the resolution conversion, the resolution may be converted to a predetermined resolution in which a defect can be sufficiently found and the image size is not excessively large, not adjusted to either one of the resolutions. Further, print data in a case where the print process is performed by using four-color toner of CMYK has pixel values of four channels of CMYK, but the read data has pixel values of three channels of RGB in most cases. Accordingly, an adjustment to either one of the pixel values is required. Then, the color conversion process is performed by using a LUT in which the correspondence between the pixel values of the print data and the pixel values of the read data is described. The LUT in this case is created in advance by obtaining the correspondence between the print data and the read data as to which pixel values of the read data correspond to the pixel values of the print data, respectively. In addition, the read data includes the print characteristics of the image forming unit 304 and the reading characteristics of the reading unit 307, and thus a correction process to add these characteristics to the print data in a simulated manner may be performed. In this way, the reference image data is generated from the print data. Incidentally, in a case where data sent from the image forming apparatus 102 is not print data but image forming data, the reference image data may be generated by performing necessary image processing on the image forming data. The reference image data generated in this way is set (stored in the RAM 402) as reference image data for the inspection job obtained in S601.

In S606, the inspection job storing unit 535 stores the inspection job obtained in S601 in the storage device 404 in association with the corresponding print job. In this case, the inspection job storing unit 535 excludes the reference image data set in S605 and stores the inspection job. In the present embodiment, the reason is to perform control to generate the reference image data by performing the RIP process again based on the print job in a case where the inspection job of the RIP inspection is reused. Incidentally, in a case where the inspection job is stored, the print job is associated with the inspection job by obtaining information, for example, a hash value or the like which can uniquely identify the corresponding print job from the image processing apparatus 101 and storing the inspect job together with the received hash value or the like.

In S607, the inspection job setting unit 531 makes the image forming apparatus 102 perform the print process using the print data generated in S602 in order to obtain the read data used for a reference image. One printed copy of the printed material to obtain the reference image data is thereby output. The details of the print process are described below.

In S608, on receiving an end signal to the effect that the printing has been performed from the CPU 201 of the image forming apparatus 102, the inspection job setting unit 531 instructs the reading control unit 533 to read the printed material which is conveyed. The reading control unit 533 receiving the instruction reads the conveyed printed material and obtains read data. The read data obtained thereby is set (stored in RAM 402) by the inspection job setting unit 531 as reference image data for the inspection job obtained in S601.

In S609, the inspection job storing unit 535 stores the inspection job obtained in S601 in the storage device 404 in association with the corresponding print job. In this case, the inspection job storing unit 535 also stores the reference image data set in S608 together. In the present embodiment, the reason is to read out and use the stored reference image data and perform control not to perform a generation process again in a case where the inspection job of the scan inspection is reused.

In S610, the print process according to the print job obtained in S601 is performed in the image forming apparatus 102. This print process is the same process as the process in S607 mentioned above and is repeated the same number of times as the number of printed copies designated in the print setting included in the header information on the print job.

In S611, the reading control unit 533 reads the printed material which is conveyed with the reading unit 307 and obtains read data (inspection image data) on an inspection target.

In S612, the defect detection unit 534 compares the inspection image data obtained in S611 with the reference image data set in S605 or S608 and examines whether there is a defect for each item designated in the inspection setting in the inspection job. Incidentally, the defect detection unit 534 performs pre-processing before the comparison as necessary. Here, the pre-processing is, for example, a resolution conversion process to match the image resolution of the inspection image data to that of the reference image data, a position adjustment process to match the positions of both images or the like. There is a possibility that the inspection image data obtained by reading the printed material includes positional shift and inclination shift resulting from print accuracy and conveyance accuracy. In a case where such an inspection image in which the positional shift and inclination shift remain included is compared with the reference image, a defect may not be detected with accuracy. Accordingly, a positional adjustment process to resolve the positional shift and the inclination shift which can be included in the inspection image is necessary. Specifically, a shift has only to be corrected by extracting characteristic points from both images, obtaining corresponding points between both images, and performing conversion to match the corresponding points. Incidentally, for example, a technique of well-known AKAZE (Accelerated KAZE) has only to be applied to the extraction of the characteristic points, and a well-known affine transformation has only to be applied to the conversion. Further, in the pre-processing, proper processes have only to be performed on the scan inspection and the RIP inspection, respectively. For example, resolution conversion is unnecessary because the inspection image and the reference image have the same resolution in a case of the scan inspection. Upon the completion of the pre-processing mentioned above, the defection detection unit 534 compares the inspection image data with the reference image data for each pixel, and a difference is calculated for each pixel. In a case where the printed material has no defect and the degree of the match between the inspection image and the reference image is high, the difference for each pixel is “0” or is within the range of values whose absolute values are small. In contrast, in a case where the printed material has a defect, a mismatch between the inspection image and the reference image is caused, and a difference whose absolute value is large is calculated in a pixel equivalent to the defect. In a case where there arises a defect in the printed material, pixels of differences whose absolute values are large occur in a cluster to some extent for each type of defect. Then, a portion in which a defect is suspected is identified by applying space filter processing in a predetermined shape to the calculated difference, and whether the portion is considered to be defective or not is determined by comparing a reaction value of a space filter with a predetermined threshold. In this way, it is possible to determine the presence or absence of a defect in the printed material. A determination result (inspection result) obtained thereby is stored in the RAM 402. Further, the printed material whose inspection ends is conveyed to the post-processing apparatus 104 and is output to a discharge tray according to the inspection result by the output control unit 542 of the post-processing apparatus 104.

In S613, in the image forming apparatus 102, whether the same number of times of printing processes as the number of printed copies designated in the print job are completed or not is determined, and in a case where the printing processes are not completed, the step returns to S610 and then the printing processes and inspection processes with respect to the results of the printing processes are continued. Further, in a case where the printing processes are completed, the step advances to S614.

In S614, the report creation unit 537 creates an inspection report based on the inspection result stored in the RAM 402. In the inspection report, information on the total number of prints, the number of accepted materials, and the number of rejected materials, or the like is described. Further, in regard to the rejected materials, the position and the type of a defect which is detected may be described. The created inspection report is stored in the storage device 404 in association with the inspection job which has been stored in S606 or S609. Incidentally, the inspection report is created as necessary, for example, in a case where an instruction to create an inspection report is included in the print job or the inspection job.

The above is the contents of the print process and inspection process based on the newly input print job.

Next, the details of the print process in S607 and S610 are described with reference to the flowchart in FIG. 8. A sequence of steps illustrated in the flowchart of FIG. 8 is realized under the control of the CPU 201 in the image processing apparatus 101.

In S801, the image processing unit 522 of the image forming apparatus 102 applies predetermined image processing to the print data received by the data obtaining unit 521, and image forming data suitable for the characteristics of the image forming unit 304 is generated. The predetermined image processing includes, for example, a color conversion process and a halftone process, or the like. In general, image forming apparatuses have various image forming characteristics attributed to the characteristics of color materials and devices to be used for each model and body of the image forming apparatuses. The image forming data generated in the preset step absorbs the difference between these characteristics and is directly referred to in a case where the image forming unit 304 performs a print process. Here, the predetermined image processing is briefly described. The color conversion process is a process to convert a color represented by an image of the print data into the amounts of color materials to be used for image forming. In a case of the present embodiment in which the image forming unit 304 performs image forming with toner of four colors C (cyan), M (magenta), Y (yellow), and K (black), the conversion is performed by using a three-dimensional, four-dimensional, or one-dimensional LUT representing conversion relation between various colors and the amounts of color materials of the above four colors. The halftone process is a process to quantize a multiple valued pixel value of each pixel constituting the print data to a smaller value (for example, a binary representing the present or absence of toner) which the image forming unit 304 can directly represent, and for example, dithering and error diffusion are used for the halftone process. The predetermined image processing is not limited to these, but a process to emphasize an edge with an edge emphasis filter may be performed in a case where, for example, the image forming unit 304 has a characteristic in which the image forming unit 304 fails to completely reproduce a sharp edge and the edge or the like becomes dull. In this way, the image forming data is generated from the print data.

In S802, the print control unit 523 drives the image forming unit 304 and forms an image on a conveyed sheet based on the image forming data. In electrophotograpy, a toner image is formed on the photoconductive drum in latent imaging and developing processes by using toner amounts prescribed in the image forming data, the toner image is transferred to the sheet, and then the toner on the sheet is fixed. The printed material is thereby created.

The above is the contents of the print process in S607 and S610. Incidentally, in a case where performing of the flow illustrated in FIG. 8 ends, the data sending unit 524 sends and receives the print data or the image forming data to and from the data obtaining unit 532. Further, an end signal to the effect that printing has been performed is sent from the image forming apparatus 102 to the inspection apparatus 103.

### <Operation Flow Based on a Stored Job>

Print and inspection processes based on a job which is stored are performed in a case where additional printing is required for some reason. In a case where the additional printing is predicted, the user includes a storing instruction in the header information on the print job to be generated and inputs the storing instruction, and as mentioned above, the print job and the inspection job corresponding to the print job continue to be stored even after the print job and the inspection job are performed. Further, in a case where the additional printing is actually required, the user instructs the start of execution of the stored print job via the input apparatus 211 of the image processing apparatus 101. Hereinafter, the print and inspection processes based on the print job and the inspection job which continue to be stored even after the print job and the inspection job are performed are described with reference to the flowchart of FIG. 9.

In S901, information on the print job stored in the storage device 204 is read out, and a list of stored jobs (not illustrated) on a display apparatus as the output apparatus 210 is presented to the user. The user who finds a desired print job in the list of the stored jobs performs an operation to select the print job via the input apparatus 211.

In S902, a selection operation of selecting the print job performed by the user is accepted, and the job obtaining unit 511 reads out and obtains the print job according to the selection operation from the storage device 204. Further, information such as a hash value which can uniquely identify the print job is sent to the inspection apparatus 103 based on the header information on the obtained print job. Incidentally, in S603 of the flow in FIG. 6 mentioned above, not only the print job but also the print data is stored together, and the print data may be read out and obtained together with the print job in the present step. In this case, next S903 is unnecessary and therefore is skipped.

In S903, as in S602 above, the print data generation unit 512 performs the RIP process based on the header information and the image data (PDL data) included in the print job obtained in S902 and generates the print data.

In S904, the inspection job setting unit 531 reads out and obtains the inspection job which is stored in association with the print job obtained in S902 from the storage device 404 based on the hash value or the like received from the image processing apparatus 101. In this case, the reference image data is also stored together in a case where the inspection method for the inspection job is the scan inspection, and the reference image data is also read out.

In S905, the inspection job setting unit 531 determines whether the inspection method is the RIP inspection or the scan inspection based on the header information on the inspection job obtained in S904. In a case where the RIP inspection is designated, S906 is performed next, and in a case where the scan inspection is designated, S907 is performed next.

In S906, as in S605 above, the inspection job setting unit 531 obtains the print data generated in S903 from the image forming apparatus 102, generates the reference image data by performing predetermined image processing on the print data, and perform setting.

In S907, the inspection job setting unit 531 sets the reference image data read out together in S904 as reference image data for the inspection job read out in S904. The reference image data used for the scan inspection is analog data obtained by scanning printed material, and in a case where the reference image data is once deleted, it is necessary to perform the operations from the creation of the printed material again. Then, in a case where an inspection method for the inspection job scheduled to be reused is the scan inspection, convenience is prioritized and the reference image data is stored in advance, and thereby printing to obtain the reference image data dose not have to be performed again. Incidentally, the user is to manually delete the reference image data in the scan inspection from the storage device 404 at the point in time of, for example, no possibility of the reuse of the reference image data.

S908 to S912 are equivalent to S610 to 614 in the flow of FIG. 6 as mentioned above, respectively, and there is nothing particularly different. Thus, a description thereof is omitted. The above is the contents of the print and inspection processes based on the stored job.

### MODIFICATION EXAMPLE 1

The above embodiment has a configuration in which the print job and the inspection job are separately generated and stored, but, for example, the contents of the inspection job may be included in the print job. In other words, information on print processing such as the number of printed copies, and the type and the size of sheets may be added to the header information on the print job, information on inspection processing such as the inspection method, and items and the level of inspection may be included, and further in addition to the PDL, the reference image data may be included. Also in this case, as in the above embodiment, in the case of the storage of the print job, whether to store the reference image data has only to be determined according to whether the inspection method is the “RIP inspection” or “scan inspection” with reference to the inspection setting in the header information.

### MODIFICATION EXAMPLE 2

Further, image information in which the position and the shape or the like of a detected defect can be visually checked may be included in the inspection report created after the inspection. In this case, for example, the report creation unit 537 creates an inspection report including the reference image used in the inspection and/or an inspection image in which a defect is detected in addition to information such as the total number of printed copies, the number of accepted materials, and the number of rejected materials. The inspection report created in this way is stored in the storage device 404 by the inspection job storing unit 535 in association with the inspection job. However, it is desirable to make small the data volume of image information to be included in the inspection report in order to avoid the shortage of the capacity of the storage device 404. In this regard, since a general state of a defect has only to be seen in the inspection report, for example, an image whose data volume is made small by degrading and reducing the resolution is used, not the reference image and/or inspection image itself. In a case where an image is A3 in size and has the resolution of 600 DPI and each pixel has 8-bit pixel values of RGB as mentioned above, used space on the storage device 404 can be reduced by a factor of 16 by, for example, converting the resolution to 150 DPI in comparison with a case where the resolution is 600 DPI.

As mentioned above, according to the present embodiment including the modification examples, whether to continue to store (hold) the reference image data on the inspection job scheduled to be reused even after the inspection is determined according to the inspection method of the inspection job. The avoidance of the shortage of the capacity of the storage device to be used for storing/holding the reference image data and the convenience to the user are thereby compatible.

### Second Embodiment

In the first embodiment, the generation of the reference image data is relatively easy in a case where the inspection method is the RIP inspection, and thus the shortage of the capacity of the storage device is avoided by not storing the reference image data after the inspection even in a case where the reuse of the reference image data is expected. However, for example, there is a case where printing and an inspection to obtain the same printed material are performed in steps of jobs. Thus, in a case where the same printing and inspection are repeatedly performed within a short period, repeating the generation of the reference image data for each time is inefficient. Then, an aspect in which the user can select whether to store (hold) the reference image data which is stored after the inspection or not in a case where the inspection method is the RIP inspection and in a case where the reference image data is held, the period of holding the reference image data is limited is described as Embodiment 2.

Incidentally, since the configuration of the print system and the operation flow or the like are basically the same as those of Embodiment 1, only the storing (holding) of the reference image data for the RIP inspection which is a difference is described below.

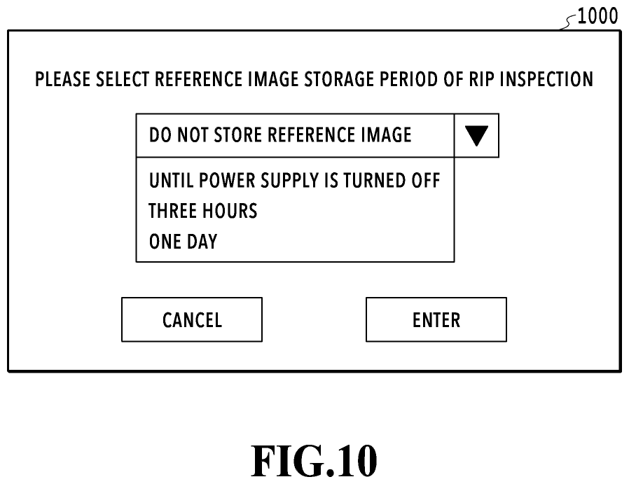

In a case of the present embodiment, in S606 of the flow of FIG. 6 mentioned above, the inspection job storing unit 535 associates reference image data with the print job together with the inspection job and stores the reference image data in the storage device 404 while providing information (storage period information) indicating a storage period (holding period). Further, a storage period in a case where the reference image data is held even after the inspection, for example, can be designated by the user via a UI screen 1000 illustrated in FIG. 10 displayed on the touch panel 309. In this case, as illustrated in the UI screen 1000 of FIG. 10, candidates of relatively short periods such as a timing in which a power supply of the print system (or each configuration apparatus) is turned off, hours, and a day (24 hours) are prepared in advance. Furthermore, the user may select one of the displayed candidates or designate any time. In addition, the inspection job storing unit 535 deletes the reference image data from the storage device 404 after the lapse of the period indicated by the storage period information.

The above is the flow of the control in a case where the reference image data is held even after the inspection also in a case of the RIP inspection in the present embodiment.

### MODIFICATION EXAMPLE

In S606 and S609 in the flow of FIG. 6 mentioned above, a UI screen (not illustrated) to make the user select whether to store the reference image data even after the inspection may be presented, and the reference image data may be stored for only a predetermined period which is determined in advance in a case where the user selects “store.” Further, regarding the predetermined period of this case, the predetermined period of a case of the reference image data for the RIP inspection is set shorter than that of a case of the reference image data for the scan inspection.

As mentioned above, according to the present embodiment, it is possible to suppress the shortage of the capacity of the storage device storing the inspection job and improve the convenience to the user in a case where the same print and inspection are repeated in a short period.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to avoid the shortage of the capacity of the storage device storing the reference image data and maintain the convenience to the user in a case where the print job is reused.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An inspection apparatus performing an inspection of printed material comprising:
one or more memories storing instructions; and
one or more processors executing the instructions:
to set reference image data generated based on print data on the printed material for the inspection; and
to store the set reference image data according to an inspection method, and hold the stored reference image data in order to reuse it for another inspection even after the inspection is performed.

2. The inspection apparatus according to claim 1, wherein the inspection method includes a first method in which the reference image data is read data obtained by reading the printed material obtained by a print process using the print data and a second method in which the reference image data is the print data to which predetermined image processing is applied; and
the set reference image data is stored in a case where the inspection method is the first method, and the set reference image data is not stored in a case where the inspection method is the second method. 3 The inspection apparatus according to claim 2, wherein information indicating a condition of the inspection including the inspection method is stored, and the stored information is held even after the inspection is performed regardless of whether the inspection method is the first method or the second method.

4. The inspection apparatus according to claim 3, wherein the one or more processors execute the instructions to: create an inspection report representing a result of the inspection, wherein
the inspection report includes an image whose volume of the reference image data used for the inspection is made small or an image whose volume of read data obtained by reading the printed material in which a defect is detected is made small, and
in a case where the reference image data is stored, the inspection report is stored in association with the information indicating the condition of the inspection.

5. The inspection apparatus according to claim 2, wherein, whether to continue to hold the set reference image data even after the inspection is performed is determined based on an instruction of a user.

6. The inspection apparatus according to claim 5, wherein the one or more processors execute the instructions to: display a UI screen to accept the instruction of the user.

7. The inspection apparatus according to claim 6, wherein a candidate of a holding period in a case of selecting to continue to hold the set reference image data and which is to be used in the second method even after the inspection is performed is displayed on the UI screen.

8. The inspection apparatus according to claim 6, wherein, in a case where the user selects to continue to hold the set reference image data and which is to be used in the second method even after the inspection is performed via the UI screen, the set reference image data and which is to be used in the second method continues to be held for a predetermined period even after the inspection is performed.

9. The inspection apparatus according to claim 1, wherein a storage device used for the storing is a volatile storage device.

10. The inspection apparatus according to claim 1, wherein, in a case where a print job giving an instruction to print the printed material is held even after the print job is performed, the set reference image data is stored and the stored reference image is held according to the inspection method even after the inspection is performed.

11. A method for controlling an inspection apparatus performing an inspection of printed material, the method comprising the steps of:
setting reference image data generated based on print data on the printed material for the inspection; and
storing the set reference image data according to an inspection method, and holding the stored reference image data in order to reuse it for another inspection even after the inspection is performed.

12. A non-transitory computer readable storage medium storing a program for causing a computer to perform a method for controlling an inspection apparatus performing an inspection of printed material, the method comprising the steps of:
setting reference image data generated based on print data on the printed material for the inspection; and
storing the set reference image data according to an inspection method, and holding the stored reference image data in order to reuse it for another inspection even after the inspection is performed.
